(19) United States
(12) Patent Application Publication
(10) Pub. No.: US 2020/0347717 A1
(43) Pub. Date: Nov. 5, 2020

(54) Apparatus of Automatic Resonance Frequency Matching for Downhole Application

(71) Applicant: GOWell International, LLC, Houston, TX (US)

(72) Inventors: Jie Li, Katy, TX (US); Qinshan Yang, Katy, TX (US); Jinsong Zhao, Houston, TX (US)

(73) Assignee: GOWell International, LLC, Houston, TX (US)

(21) Appl. No.: 16/403,315

(22) Filed: May 3, 2019

(51) Int. Cl. E21B 47/00; E21B 47/01; E21B 47/14; G01V 1/52; G01V 1/50; G01V 1/46

(52) U.S. Cl. CPC E21B 47/0005; E21B 47/011; E21B 47/14; G01V 2210/6226; G01V 1/50; G01V 1/46; G01V 2001/526; G01V 1/523

(57) ABSTRACT

A system and method for inspecting cement downhole in multi-casing wells. The method may comprise inserting an inspection device into a tube. The inspection device may comprise a plurality of transducers, wherein the plurality of transducers comprise one or more transducers. Further, the inspection device may comprise an inner tubing and at least one mount. The method for inspecting cement downhole may further comprise exciting the plurality of transducers, sweeping the plurality of transducers from a minimum frequency value to a maximum value, and matching frequency value of the plurality of transducers to a frequency value of a target structure.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND OF THE INVENTION

### Field of the Disclosure

This disclosure relates to a downhole tool that may be capable of evaluating a cement bond layer in multi-casing wells. Operating in an adjustable broad frequency range to match a target structure's resonance frequency may aid in Through Tubing Cement Bond Logging (TTCBL) evaluation by enhancing signal-to-noise ratio.

### Background of the Disclosure

In oil well production, tubing may be used in many different applications and may transport many types of fluids. The tubing may be surrounded and/or encased by casing. The casing may be a series of steel pipes that are placed into a drilled oil well and used to stabilize the well, keep contaminants and water out of the oil stream, and/or prevent oil from leaking into the groundwater. Further, the casing may be installed in layers, e.g. sections of decreasing diameter that are joined together to form casing strings. In order to support these casings strings, prevent fluid from leaking to the surface, and/or isolate producing zones from water-bearing zones, cement may be deployed between the casing and formation of the well. To ensure proper cement placement, it is beneficial to evaluate the interface between the casing and the cement. Previous methods for inspecting cement have come in the form of non-destructive inspection tools that may transmit linear acoustic waves that may be reflected and recorded for analysis. However, previous methods may not be able to effectively perform measurements of the interface between the casing and cement in wells with multiple layers of casing.

Currently, methods for analyzing log data measured by TTCBL tools are typically developed for oil wells with single-casing geometries, e.g. oil wells with a single layer of pipe. These methods emit a single pulsed acoustic wave and analyze the received signal in order to evaluate the properties of a target structure. However, in oil wells consisting of casing with multiple layers, e.g. more than one pipe, wherein the pipes are layered in a concentric configuration, the energy of a single pulsed acoustic wave will dissipate during propagation between inner and outer layers of the casing and the received signal will be too weak to analyze in TTCBL evaluation.

Additionally, methods for analyzing data measured by TTCBL tools are based on resonance frequency of the target structure. Properties of the target structure and/or the geometry of the multiple layers of pipe may cause the resonance frequency of the target structure to shift in value. A single narrowband frequency signal such as the single pulsed acoustic wave used in current methods will not be able to accurately capture this shift in resonance frequency. Therefore, current TTCBL tools will not be able to accurately evaluate a cement bond layer in oil wells with multiple layers of casing.

Consequently, there is a need for an improved system and method for TTCBL evaluation in multi-casing wells.

### BRIEF SUMMARY OF SOME OF THE PREFERRED EMBODIMENTS

These and other needs in the art may be addressed in embodiments by a device and method for evaluating cement bonds in multi-casing wells.

An inspection system may comprise a plurality of transducers, wherein the plurality of transducers comprises one or more transducers with one or more segments. Further, the plurality of transducers may function as a transmitter and receiver simultaneously. The inspection system may also comprise an inner tubing and at least one mount.

A method for inspecting cement downhole may comprise inserting an inspection device into a tube. The inspection device may comprise a plurality of transducers, wherein the plurality of transducers comprises one or more transducers. Further, the inspection device may comprise an inner tubing and at least one mount. The method for inspecting cement downhole may further comprise exciting the plurality of transducers, sweeping the operating frequency of the plurality of transducers from a minimum frequency value to a maximum value, and matching frequency value of the plurality of transducers to a frequency value of a target structure.

The foregoing has outlined rather broadly the features and technical advantages of the present invention in order that the detailed description of the invention that follows may be better understood. Additional features and advantages of the invention will be described hereinafter that form the subject of the claims of the invention. It should be appreciated by those skilled in the art that the conception and the specific embodiments disclosed may be readily utilized as a basis for modifying or designing other embodiments for carrying out the same purposes of the present invention. It should also be realized by those skilled in the art that such equivalent embodiments do not depart from the spirit and scope of the invention as set forth in the appended claims.

### BRIEF DESCRIPTION OF THE DRAWINGS

For a detailed description of the preferred embodiments of the invention, reference will now be made to the accompanying drawings in which:

FIG. 1 illustrates an embodiment of an inspection system disposed downhole.

FIG. 2 illustrates an embodiment of a plurality of transducers with cylindrical shape.

FIG. 3A illustrates an embodiment of a transducer with a four segments.

FIG. 3B illustrates an embodiment of a transducers with eight segments.

FIG. 4 illustrates a graph showing the optimal cylindrical size of a transducer based on radial resonance frequency.

FIG. 5 illustrates an embodiment of an inspection device operating downhole.

FIG. 6 illustrates a graph of coupled and independent signals emitted during operation.

FIG. 7 illustrates a graph of the relationship between frequency response and properties of the target structure.

### DETAILED DESCRIPTION OF THE PREFERRED EMBODIMENTS

The present disclosure relates to embodiments of a device and method for inspecting and detecting properties of cement attached to casing. More particularly, embodiments of a device and method are disclosed for inspecting cement walls surrounding casing in wells with multiple layers of casing downhole. In embodiments, an inspection device may operate in an adjustable broad frequency range to match resonance frequency of a target structure. By matching the resonance frequency of the target structure, the inspection device may be capable of enhancing signal-to-noise ratio for TTCBL evaluation in multi-casing wells.

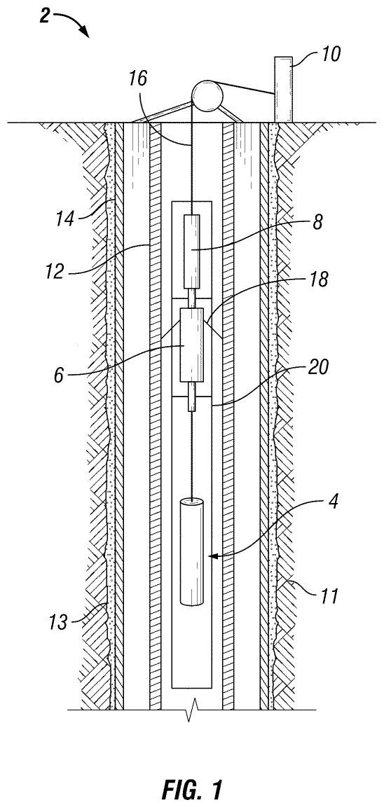

FIG. 1 illustrates an inspection system 2 comprising an inspection device 4, a centralizing module 6, a telemetry module 8, and a service device 10. In embodiments, inspection device 4 may be inserted into a tubing 12, wherein tubing 12 may be contained within a casing 14, wherein casing 14 may comprise a series of steel pipes. In embodiments, casing 14 may be supported by a cement bond layer 13 disposed between casing 14 and an underground formation 11, wherein cement bond layer 13 may be capable of preventing fluid from leaking to the surface and isolating producing zones from water-bearing zones. In further embodiments, there may be a plurality of tubing 12, wherein an inner tube may be contained by several additional tubes in a concentric configuration. Additionally, in further embodiments, there may be a plurality of casing 14, wherein an inner pipe may be contained by several additional pipes in a concentric configuration. In embodiments, as shown, inspection device 4 may be disposed below centralizing module 6 and telemetry module 8. In other embodiments, not illustrated, inspection device 4 may be disposed above and/or between centralizing module 6 and telemetry module 8. In embodiments, inspection device 4, centralizing module 6, and telemetry module 8 may be connected to a tether 16. Tether 16 may be any suitable cable that may support inspection device 4, centralizing module 6, and telemetry module 8. A suitable cable may be steel wire, steel chain, braided wire, metal conduit, plastic conduit, ceramic conduit, and/or the like. A communication line, not illustrated, may be disposed within tether 16 and connect inspection device 4, centralizing module 6, and telemetry module 8 with service device 10. Without limitation, inspection system 2 may allow operators on the surface to review recorded data in real time from inspection device 4, centralizing module 6, and telemetry module 8.

As illustrated in FIG. 1, service device 10 may comprise a mobile platform (e.g. a truck) or stationary platform (e.g. a rig), which may be used to lower and raise inspection system 2. In embodiments, service device 10 may be attached to inspection system 2 by tether 16. Service device 10 may comprise any suitable equipment which may lower and/or raise inspection system 2 at a set or variable speed, which may be chosen by an operator. The movement of inspection system 2 may be monitored and recorded by telemetry module 8.

Telemetry module 8, as illustrated in FIG. 1, may comprise any devices and processes for making, collecting, and/or transmitting measurements. For instance, telemetry module 8 may comprise an accelerator, gyro, and the like. In embodiments, telemetry module 8 may operate to indicate where inspection system 2 may be disposed within tubing 12. Telemetry module 8 may be disposed at any location above, below, and/or between centralizing module 6 and inspection device 4. In embodiments, telemetry module 8 may send information through the communication line in tether 16 to a remote location such as a receiver or an operator in real time, which may allow an operator to know where inspection system 2 may be located within tubing 12. In embodiments, telemetry module 8 may be centered laterally in tubing 12.

As illustrated in FIG. 1, centralizing module 6 may be used to position inspection device 4 and/or telemetry module 8 inside tubing 12. In embodiments, centralizing module 6 laterally positions inspection device 4 and/or telemetry module 8 at about a center of tubing 12. Centralizing module 6 may be disposed at any location above and/or below telemetry module 8 and/or inspection device 4. In embodiments, centralizing module 6 may be disposed above inspection device 4 and below telemetry module 8. Centralizing module 6 may comprise a plurality of arms 18. In embodiments, plurality of arms 18 that may be disposed at any location along the exterior of centralizing module 6. In an embodiment, as shown, at least one arm of plurality of arms 18 may be disposed on opposing lateral sides of centralizing module 6. Additionally, plurality of arms 18 may comprise at least three arms disposed on the outside of centralizing module 6. Plurality of arms 18 may be moveable at about the connection with centralizing module 6, which may allow a body of each arm to be moved closer and farther away from centralizing module 6. Plurality of arms 18 may comprise any suitable material. Suitable material may be, but is not limited to, stainless steel, titanium, metal, plastic, rubber, neoprene, and/or any combination thereof. In embodiments, the addition of springs, not illustrated, may further make up and/or be incorporated into centralizing module 6. The springs may assist plurality of arms 18 in moving centralizing module 6 away from tubing 12, and thus inspection device 4 and telemetry module 8, to about the center of tubing 12. Without limitation, centering inspection device 2 may produce more reliable and accurate voltage readings of tubing 12 and/or cement bond layer 13.

Inspection device 4, as illustrated in FIG. 1, may be located below centralizing module 6 and/or telemetry module 8. Inspection device 4 may be designed to evaluate cement bond layer 13 in a wellbore with a plurality of casing 14 by automatically matching resonance frequency of a target structure. Casing 14 may be made of any suitable material for use in a wellbore. Suitable material may be, but is not limited to, stainless steel, aluminum, titanium, fiber glass, and/or any combination thereof. Additionally, any type of cement may make up cement bond layer 13. As previously discussed, there may be a plurality of casing 14 wherein an inner pipe may be encompassed by several additional pipes in a concentric configuration. In embodiments, inspection device 4 may comprise a housing 20. Housing 20 may be any suitable length in which to protect and house the components of inspection device 4. In embodiments, housing 20 may be made of any suitable material to resist corrosion and/or deterioration from a fluid. Suitable material may be, but is not limited to, titanium, stainless steel, plastic, and/or any combination thereof. Housing 20 may be any suitable length in which to properly house the components of inspection device 4. A suitable length may be about one foot (0.3048 meters) to about ten feet (3.048 meters), about four feet (1.2192 meters) to about eight feet (2.4384 meters), about five feet (1.524 meters) to about eight feet (2.4384 meters), or about three feet (0.9144 meters) to about six feet (1.8288 meters). Additionally, housing 20 may have any suitable width. A suitable diameter may be about one foot (0.3048 meters) to about three feet (0.9144 meters), about one inch (2.54 centimeters) to about three inches (7.62 centimeters), about three inches (7.62 centimeters) to about six inches (15.24 centimeters), about four inches (10.16 centimeters) to about eight inches (20.32 centimeters, about six inches (15.24 centimeters) to about one foot (0.3048 meters), or about six inches (15.24 centimeters) to about two feet (0.6096 meters). Housing 20 may protect the components of inspection device 4 from the surrounding downhole environment within tubing 12. Further, the inside of housing 20 may be filled with oil in order to control pressure of inspection device 4.

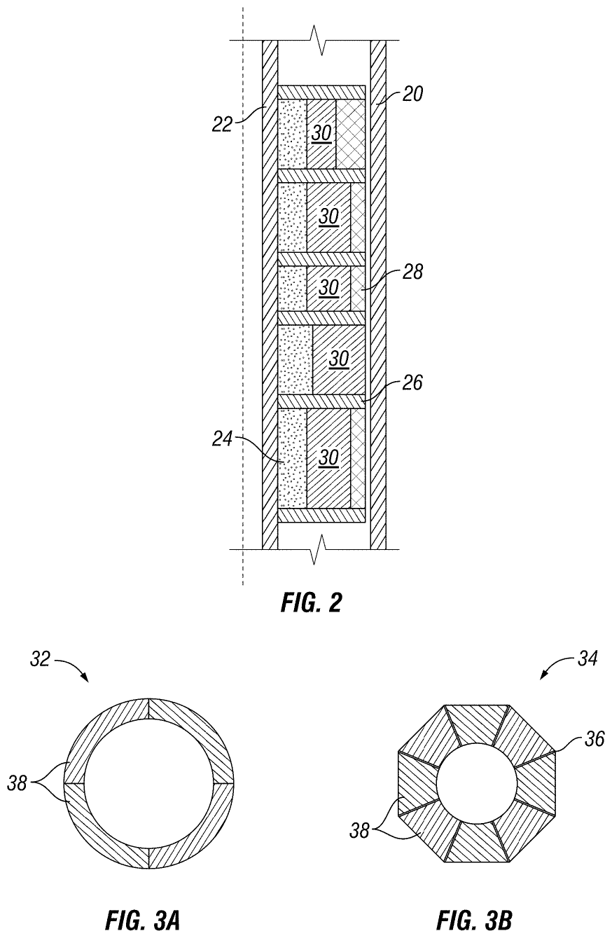

FIG. 2 illustrates an embodiment of inspection device 4. In embodiments, inspection device 4 may comprise housing 20 (previously described), an inner tube 22, damping materials 24, a plurality of mounts 26, supporting materials 28, and a plurality of transducers 30. As illustrated in FIG. 2, in embodiments inner tube 22 may be disposed at the center of inspection device 4. In embodiments, inner tube 22 may be used to connect plurality of transducers 30. Suitable material for inner tube 22 may be, but is not limited to stainless steel, aluminum, titanium, fiber glass, and/or any combination thereof. Inner tube 22 may be any suitable length in which to properly connect plurality of transducers 30. A suitable length may be about one foot (0.3048 meters) to about ten feet (3.048 meters), about four feet (1.2192 meters) to about eight feet (2.4384 meters), about five feet (1.524 meters) to about eight feet (2.4384 meters), or about three feet (0.9144 meters) to about six feet (1.8288 meters). Additionally, inner tube 22 may have an outer and inner diameter of any suitable length in order to connect plurality of transducers 30. The length of the outer diameter may be about 10 millimeters to about 20 millimeters and the length of the inner diameter may be about 1 millimeter to about 18 millimeters. In some embodiments, inner tube 22 may be a rod which has an inner diameter of zero. In order to connect plurality of transducers 30, inner tube 22 may use damping materials 24.

Damping materials 24, as illustrated in FIG. 2, may be disposed between plurality of transducers 30 and inner tube 22. In embodiments, damping materials 24 may be used to connect plurality of transducers 30 to inner tube 22. The use of damping materials 24 may result in the damping of plurality of transducers 30. More specifically, use of damping materials 24 may reduce Q value of each transducer of plurality of transducers 30. Q value or quality factor of a transducer, describes the amount of ringing the transducer undergoes when power may be applied to it. A low Q value may enhance working frequency range of each transducer of plurality of transducers 30. However, low Q value may also reduce performance, e.g. sensitivity and/or signal to noise ratio, of each transducer of plurality of transducers 30. A suitable material may be, but is not limited to, viscoelastic material such as PEEK. PEEK is a strong, stiff plastic with high chemical resistance and the ability to maintain stiffness at high temperatures up to 338° F. (170° C.). Further, viscoelastic material exhibits both viscous and elastic characteristics when undergoing deformation and therefore, may be capable of effectively damping plurality of transducers 30.

Disposed between each transducer of plurality of transducers 30 may be a mount of plurality of mounts 26. In embodiments, plurality of mounts 26 may be used to mount each transducer and prevent interaction between plurality of transducers 30. Isolation of each transducer may enhance the performance of plurality of transducers 30. Suitable material for plurality of mounts 26 may be, but is not limited to, damping material such as Teflon.

In some embodiments, supporting materials 28 may be disposed between plurality of transducers 30 and the oil (not illustrated) used to fill housing 20 of inspection device 4. Suitable material for supporting materials 28 may be any non-damping material such as, though not limited to, stainless steel, aluminum, titanium, fiber glass, and/or any combination thereof. In embodiments, support material may be used for maintaining placement of plurality of transducers 30 disposed within housing 20 of inspection device 4.

Further illustrated in FIG. 2, plurality of transducers 30 may be disposed between damping materials 24, supporting materials 28, and plurality of mounts 26. In embodiments, plurality of transducers 30 may comprise a variable number of transducers. FIG. 2 illustrates inspection device 4 made up of five transducers. However, this number may be any value greater than or equal to one. The number of transducers of the plurality of transducers 30 may depend on the operating bandwidth of each transducer. Further, the number of transducers may depend on the desired frequency range in which a user needs to operate inspection device 4. Each transducer may be made up of piezoelectric material which may be capable of mechanical movement as a result of an electric charge.

FIGS. 3A and 3B illustrate example geometries of two transducers of the plurality of transducers 30 disposed in inspection device 4. FIGS. 3A and 3B illustrate horizontal cross-sections of the two transducers. In embodiments, each transducer of plurality of transducers 30 may have a cylindrical shape and axisymmetric geometry. Further, each transducer of plurality of transducers 30, may comprise a plurality of segments 38 which may vary in number of segments between each transducer. FIG. 3A shows an example of a first transducer 32 with four segments. FIG. 3B shows an example of a second transducer 34 with eight segments. In embodiments, the number of segments of each transducer may be any value greater than or equal to one. In further embodiments, a material 36 may be disposed between each segment, as illustrated in FIG. 3B, in order to connect plurality of segments 38 and add support to each transducer of plurality of transducers 30. Material 36 may be any damping and/or non-damping material such as, though not limited to, PEEK, Teflon, rubber, stainless steel, aluminum, titanium, fiber glass, and/or any combination thereof. In some embodiments, material 36 may be an adhesive, e.g. glue, which may connect each segment together. The number of segments and shape of each segment may vary based on the users desired output signal.

In addition to the number of segments and the shape of each segment, the geometry of each transducer such as the inner diameter, outer diameter, and length may vary based on the desired resonance frequency at which the user wishes to operate the transducer. For example, each transducer may be designed with a same or different frequency range which may excite the transducer in the radial direction at the resonance frequency with a broad bandwidth. The broad bandwidth may comprise various ranges such as, though not limited to, from about 3 kHz to about 5 kHz. In embodiments, the preferred inner diameter, outer diameter, and length of each transducer may be determined using the coupled vibration theory of the cylindrical transducer and may be optimized to obtain purely circumferential motion at variable frequencies. The three-dimensional motion equations for a cylindrical transducer in longitudinal-radial coupled vibration may be disclosed below:

$$\begin{matrix}ρ \frac{{\partial }^{2} {ξ}_{r}}{\partial {t}^{2}} = \frac{\partial {T}_{r}}{\partial r} + \frac{1}{r} \frac{\partial {T}_{r θ}}{\partial θ} + \frac{\partial {T}_{r z}}{\partial z} + \frac{{T}_{r} - {T}_{θ}}{r} & ( 1 ) \\ ρ \frac{{\partial }^{2} {ξ}_{θ}}{\partial {t}^{2}} = \frac{\partial {T}_{r θ}}{\partial r} + \frac{1}{r} \frac{\partial {T}_{θ}}{\partial θ} + \frac{\partial {T}_{θ z}}{\partial z} + \frac{2 {T}_{r θ}}{r} & ( 2 ) \\ ρ \frac{{\partial }^{2} {ξ}_{z}}{\partial {t}^{2}} = \frac{θ {T}_{r z}}{\partial r} + \frac{1}{r} \frac{\partial {T}_{θ z}}{\partial θ} + \frac{\partial {T}_{z}}{\partial z} + \frac{{T}_{r z}}{r} & ( 3 )\end{matrix}$$

In Equations 1-3, the density of the piezoelectric material may be represented by ρ, the radial, tangential, and axial displacement may be represented by ξᵣ, ξ_{η}, and ξ_{z}, respectively, and the stresses of each transducer may be represented by Tᵣ, T_{θ}, T_{z}, T_{rθ}, T_{rz}, and T_{θz}, each corresponding to a respective direction. In addition to these variables, the strain of each transducer may also be needed to determine the inner diameter, outer diameter, and length. Strain may be represented by Sᵣ, S_{θ}, S_{z}, S_{rθ}, S_{rz}, and S_{θz}. Due to the axial symmetry of plurality of transducers 30, each transducer's stress and strain may be expressed as four independent variables because S_{rθ}=S_{θz=}0 and T_{θz}=T_{rθ}=0. The relationship between strain and displacement may be reduced to the following form:

$$[ \begin{matrix}{S}_{r} \\ {S}_{θ} \\ {S}_{z} \\ {S}_{rz}\end{matrix} ] = [ \begin{matrix}\frac{\partial {ξ}_{r}}{\partial r} \\ \frac{{ξ}_{r}}{r} \\ \frac{\partial {ξ}_{z}}{\partial z} \\ \frac{\partial {ξ}_{r}}{\partial z} + \frac{\partial {ξ}_{z}}{\partial r}\end{matrix} ] . \qquad ( 4 )$$

In embodiments, the transducer may be a short, thin-walled, cylindrical transducer, in which the length and the width (inner diameter subtracted from the outer diameter) of the transducer is significantly less than its outer diameter. In this case, piezoelectric constitutive equations may be obtained in pure radial vibration as follows:

S_{θ}=S₁₁^{E}T_{θ}+d₃₁E₃ (5)

D₃=d₃₁T_{θ}+ε₃₃^{T}E₃ (6)

In Equations 5 and 6, S₁₁^{E} may represent the elastic compliance constant, d₃₁ may represent the piezoelectric strain constant, ε₃₃^{T} may be the dielectric constant, E₃ may represent the radial external exciting electric field, and D₃ may represent the radial electric displacement.

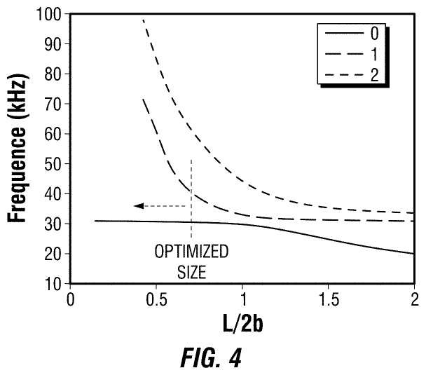

Based on Equations 1-6, the inner diameter, outer diameter, and length of each transducer of plurality of transducers 30 may be determined and optimized to obtain pure radial vibration. FIG. 4 illustrates the relationship between transducer size and radial (mode 0), flexural (mode 1), and longitudinal (mode 2) resonance frequency based on Equations 1-6. In embodiments, the resonance frequency may be predicted by the size of each transducer of plurality of transducers, as shown in FIG. 3.

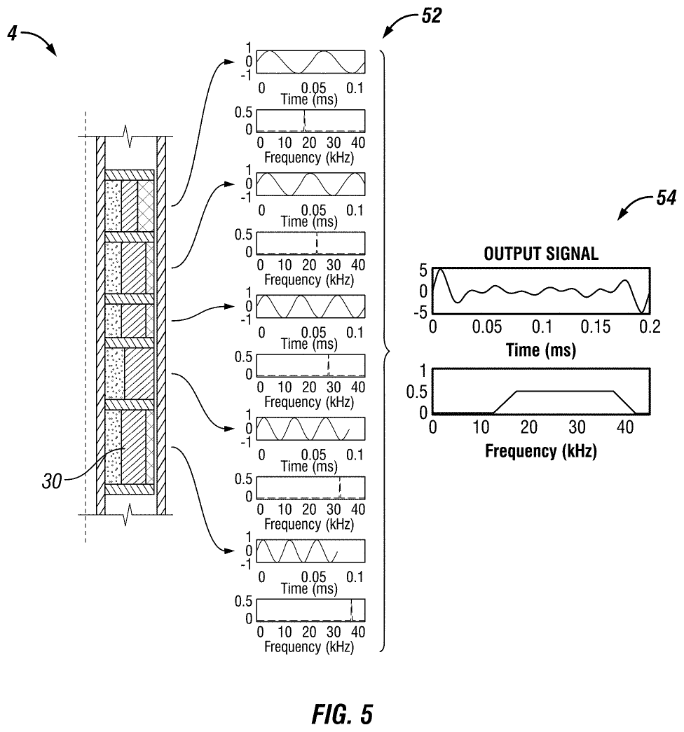

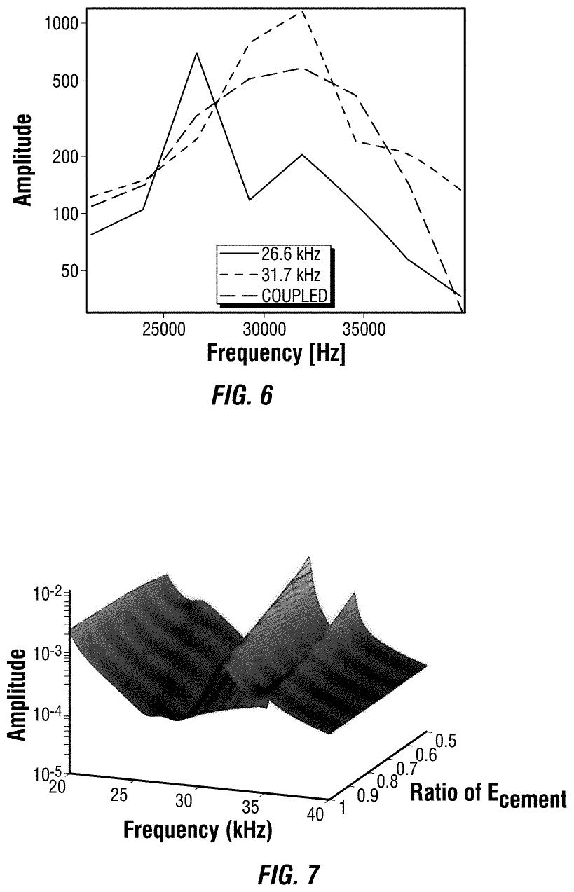

FIG. 5 illustrates an example of the operation of inspection device 4 during evaluation of properties of a target structure. In embodiments, inspection device 4 may be inserted into a multi-casing well. Inspection device 4 may determine an operating frequency range of at which a target structure will vibrate on its resonance frequency by sweeping in frequency from a maximum to a minimum value. The maximum and minimum values may be around 20 to 40 kHz as shown in individual signals 52 of plurality of transducers 30 in FIG. 5. In embodiments, each signal of individual signals 52 may be of any amplitude, frequency, or phase capable of being produced by the corresponding transducer of plurality of transducers 30. By combining individual signals 52 the operator may produce a desired output signal 54. In further embodiments, inspection device 4 may function on the operation frequency range with one or multiple excited transducers of plurality of transducers 30. Exciting each transducer may be accomplished by using a mixed sine wave signal, as illustrated in FIG. 6, or using a chirp signal.

In FIG. 6, the mixed sine wave signal may be generated using the following equation:

$$V ( t ) = A {\sum }_{i = 1}^{n} sin ( 2 π {f}_{i} t ) \qquad ( 7 )$$

In Equation 7, V(t) may be the input voltage to a transducer of plurality of transducers 30, A may be the amplitude, and fₙ may be the target frequency, i=1, 2, 3 . . . n.

In embodiments in which the chirp signal may be used to excite plurality of transducers 30, the signal may be generated using following equations:

$$\begin{matrix}V ( r ) = A sin ( 2 π f ( t ) t ) & ( 8 ) \\ f ( t ) = {f}_{0} + \frac{( {f}_{T} - {f}_{0} ) t}{T} & ( 9 )\end{matrix}$$

In Equations 8 and 9, f₀ and f_{T} may be the low and high bound values of the frequency range, respectively, and T may be the time used to reach the highest frequency.

These signals may be processed and interpolated with different methods to evaluate the properties of the target structure such as the frequency response functions (FRFs) as shown in FIG. 6, or the acoustic impedance analysis. In embodiments, plurality of transducers 30 may work simultaneously as a transmitter and a receiver in order to emit signals and receive the signal response.

As illustrated in FIG. 7, a curve may be obtained showing the relationships between amplitude, frequency, and properties of the target structure. The material properties of the target structure may be estimated based on the FRFs. In embodiments, the vibration equation without damping may be as follows:

[M]{\ddot{x}}+[K {x}={f} (10)

In Equation 10 [M] may be the mass matrix and [K] may be the stiffness matrix that contain material properties of the target structure. After Laplace transform and simplification, Equation 10 may become:

$$[ H ( s ) ] = \frac{\{ X ( s ) \}}{\{ F ( s ) \}} \qquad ( 11 )$$

In Equation 11 {X(s)} may be the response signal and {F(s)} may be the exciting signal, s. may be the complex frequency, and the [H(s)] may be the transfer function matrix as:

[H(s)]=[s²[M]+[K]]⁻¹ (12)

The change of mass and stiffness of the target structure may be calculated based on Equations 11 and 12, and obtained results may be shown in FIG. 7. Therefore, by this method, the properties of a target structure in a multi-casing oil well may be obtained and evaluated.

Although the present invention and its advantages have been described in detail, it should be understood that various changes, substitutions and alterations may be made herein without departing from the spirit and scope of the invention as defined by the appended claims.

It should be understood that the compositions and methods are described in terms of “comprising,” “containing,” or “including” various components or steps, the compositions and methods can also “consist essentially of” or “consist of” the various components and steps. Moreover, the indefinite articles “a” or “an,” as used in the claims, are defined herein to mean one or more than one of the elements that it introduces.

For the sake of brevity, only certain ranges are explicitly disclosed herein. However, ranges from any lower limit may be combined with any upper limit to recite a range not explicitly recited, as well as, ranges from any lower limit may be combined with any other lower limit to recite a range not explicitly recited, in the same way, ranges from any upper limit may be combined with any other upper limit to recite a range not explicitly recited. Additionally, whenever a numerical range with a lower limit and an upper limit is disclosed, any number and any included range falling within the range are specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values even if not explicitly recited. Thus, every point or individual value may serve as its own lower or upper limit combined with any other point or individual value or any other lower or upper limit, to recite a range not explicitly recited.

Therefore, the present embodiments are well adapted to attain the ends and advantages mentioned as well as those that are inherent therein. The particular embodiments disclosed above are illustrative only, and may be modified and practiced in different but equivalent manners apparent to those skilled in the art having the benefit of the teachings herein. Although individual embodiments are discussed, the invention covers all combinations of all those embodiments. Furthermore, no limitations are intended to the details of construction or design herein shown, other than as described in the claims below. Also, the terms in the claims have their plain, ordinary meaning unless otherwise explicitly and clearly defined by the patentee. It is therefore evident that the particular illustrative embodiments disclosed above may be altered or modified and all such variations are considered within the scope and spirit of the invention. If there is any conflict in the usages of a word or term in this specification and one or more patent(s) or other documents that may be incorporated herein by reference, the definitions that are consistent with this specification should be adopted.

1. An inspection system comprising:
an inspection device comprising:
a plurality of transducers comprising one or more segments, wherein the plurality of transducers is simultaneously a transmitter and receiver;
an inner tubing; and
at least one mount.

2. The inspection system of claim 1, wherein each transducer of the plurality of transducers is developed as a Through Tubing Cement Bond Logging evaluation device.

3. The inspection system of claim 1, wherein the plurality of transducers comprises an axisymmetric geometry

4. The inspection system of claim 1, wherein the plurality of transducers comprises piezoelectric material.

5. The inspection system of claim 1, wherein the inner diameter, the outer diameter, and the length of each transducer of the plurality of transducers is determined by resonance frequency of a target structure.

6. The inspection system of claim 1, wherein the number of transducers is determined by a bandwidth of each transducer, a proposed frequency range, or a combination thereof.

7. The inspection system of claim 1, wherein each transducer of the plurality of transducers is designed to operate in a frequency range, wherein the frequency range excites each transducer.

8. The inspection system of claim 1, wherein each transducer is excited at a resonance frequency with a broad bandwidth.

9. The inspection system of claim 1, wherein each transducer of the plurality of transducers is connected to the inner tube using a viscoelastic material.

10. The inspection system of claim 1, wherein each transducer of the plurality of transducers is separated by the at least one mount to prevent contact between each transducer, wherein the at least one mount is made up of damping material.

11. The inspection system of claim 1, wherein supporting material is disposed between the plurality of transducers and a housing.

12. The inspection system of claim 1 further comprising:
a centralizing module;
a telemetry module; and
a service device.

13. The inspection system of claim 11, wherein the centralizing module comprised one or more arms used to centralized the inspection device.

14. The inspection system of claim 11, wherein the telemetry module comprises devices and/or processes for making data, collecting data, transmitting data, or any combination thereof.

15. The inspection system of claim 11, where the service device comprises:
a platform, wherein the platform is mobile or stationary; and
a tether, wherein the tether is used to connect the platform to the inspection system.

16. A method for inspecting cement downhole comprising:
inserting an inspection device into a tube, wherein the inspection device comprises a plurality of transducers, an inner tubing, and at least one mount;
exciting the plurality of transducers;
sweeping operating frequency of the plurality of transducers in a range of various frequencies; and
matching frequency value of the plurality of transducers to a frequency value of a target structure.

17. The method of claim 16, further comprising sending out a continued acoustic wave to find a matched frequency that the target structure will vibrate on.

18. The method of claim 17, wherein the matched frequency is the resonance frequency of the target structure.

19. The method of claim 16, wherein the inspection device will operate on a matched frequency range with one or multiple excited transducers, wherein the different exciting methods comprise using a mixed sine wave signal or a chirp signal.

20. The method of claim 16, further comprising processing and interpolating a signal using Frequency Response Functions and/or acoustic impedance analysis to evaluate properties of the target structure.
